(19) United States
(12) Patent Application Publication
(10) Pub. No.: US 2007/0025824 A1
(43) Pub. Date: Feb. 1, 2007

(54) Structure having space reserved for gel overflow of electronic product

(75) Inventors: Yung-Chi Yang, Taipei (TW); Steven Wang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/391,504

(22) Filed: Mar. 27, 2006

(30) Foreign Application Priority Data
Jul. 29, 2005 (TW) 94212917

(51) Int. Cl. F16B 39/02

(52) U.S. Cl. 411/82

(57) ABSTRACT

A structure having space reserved for gel overflow of an electronic product is provided on a casing of the electronic product. The structure includes a fastening portion and an overflow valley, wherein the fastening portion is used for combining a screwing component to assemble a casing of the electronic product; and the overflow valley is provided in an inner rim of the fastening portion for depositing hot gel therein generated when combining the screwing component. As a result, the interference between the screwing component and the casing can be prevented.

### FIELD OF THE INVENTION

The present invention relates to a casing structure of electronic products, and more particularly to a structure having space reserved for gel overflow applied in casing structures of notebook computers.

### BACKGROUND OF THE INVENTION

As electronic products such as computers can perform complicated algorithms of programs and manage enormous data system and summarize data into information for users, electronic products are pervasive to people of all age. Particularly, notebook computers are being developed along the trend of miniaturized and portable electronic products. Facing fierce market competition, inventions and research which can miniaturize the size of electronic products and reduce manufacture cost in design, manufacturing and/or assembly are of major concerns. Accordingly, any improved invention with effective functions such as saving space or reducing manufacture cost are valuable in product use to those in the art.

As shown in FIG. 1, a conventional structure of an electronic product such as a notebook computer includes a frame 2 and a casing 4 correspondingly combined with each other, wherein a motherboard (not shown) is mounted between the frame 2 and the casing 4. The motherboard generally integrates peripheral devices such as a hard disk, a CD-ROM, a battery, a modem, a network card and the like; and the casing 4 further includes an upper casing 41 having openings for assembling a keyboard and a cursor touch panel, and a lower casing 43 formed with a space for accommodating required components and devices after assembling to the upper casing 41.

In such structure of the notebook computers, in order to fasten the frame 2 and the casing 4 by a plurality of screwing components 6 such as screws and nails, a plurality of through-holes 21 in the frame 2 and lock-holes 431 in the casing 4 should be provided in corresponding positions. Generally, the plurality of lock-holes 431 are provided in the lower casing 43 of the case 4, and a plurality of through-holes 21 are provided in the frame 2 according to the lock-holes 431. The screwing components 6 are often disposed in areas which cover a portion of the casing 4 and central areas near the keyboard and the cursor touch panel. While assembling the structure, the screwing components 6 are locked upward through the lock-holes 431 of the lower casing 43 and the motherboard to the frame 2, and then the frame 2 is locked upward to the upper casing 41, such that the casing 4 can be combined to the frame 2 tightly. The surface flatness of the casing 4 has to be ensured to avoid abrasion of a panel 8 such as a LCD by partially projecting casing 4.

As shown in FIG. 2A, a shallow circular opening is first prepared while forming the lower casing 43. A space which is at least 0.2 mm is usually reserved under the lock-hole 431 for avoiding gel overflow. Then as shown in FIG. 2B, the lower casing 43 is hot melted by the screwing component 6 so that a spiral hole (i.e. lock-hole 431) is formed for locking the screwing component 6.

However, an overflow space which is no less than 0.2 mm cannot be properly ensured due to mechanical design consideration. Thus, interference between the screwing component 6 and the lower casing 43 may occur as hot gel is deposited in the bottom of the lock-hole 431 while melting the lower casing 43. In order to avoid the interference, the overflow space can be increased by extending the height of the lock-hole 431 along the direction towards the frame 2, but this inevitably increases the overall thickness of the structure; otherwise the circuit layout of the motherboard has to be carefully designed around the positions of the screwing components 6 such that the complexity of the layout may be raised. Accordingly, not only the design freedom of the motherboard layout is compromised, but often the size of the motherboard is enlarged and so as the volume of the motherboard structure.

Moreover, in order not to increase the thickness of the structure and influence of the motherboard layout, the height of the overflow space of the lock-hole 431 can be increased away from the frame 2. However, the more the lock-holes 431 are projecting out of the outer surface of the lower casing 43, less balance there is for the overall structure since the screwing components 6 are not distributed evenly. Accordingly, a plurality of supporting portions needs to be added on the outer surface of the lower casing 43 to maintain balance; thereby the resulting structure may be more complicated. Furthermore, price of the formed mould, required material for forming the casing and manufacturing cost increase with the increasing amount of the supporting portions.

As a result, there is a need in the art to provide a structure having space reserved for gel overflow in an electronic product so as to save internal space and material of the electronic product and reduce manufacturing cost.

### SUMMARY OF THE INVENTION

In view of the abovementioned shortcomings of the prior art, it is a primary objective of the present invention to provide a structure having space reserved for gel overflow of an electronic product for saving space.

It is another objective of the present invention to provide a structure having space reserved for gel overflow of an electronic product for saving material.

It is a further objective of the present invention to provide a structure having space reserved for gel overflow of an electronic product for reducing manufacturing cost and increasing the design flexibility of circuit layout.

In order to achieve the abovementioned and other objectives, a structure having space reserved for gel overflow of an electronic product is proposed according to the present invention. The structure is provided on a casing of the electronic product comprises a fastening portion and an overflow valley, wherein the fastening portion is used for combining a screwing component so as to assemble the casing of the electronic product; and the overflow valley is provided in inner rim of the fastening portion for depositing hot gel therein generated when combining the screwing component. As a result, the interference between the screwing component and the casing can be effectively prevented.

Preferably, the fastening portion may be a lock-hole, for example a circular opening. In one embodiment, the fastening portion may be a structure extended from an outer surface of the casing, and for example a structure projected out of the outer surface of the casing. In another embodiment, the fastening portion may be a structure that is leveled with the outer surface of the casing. The overflow valley may be a stepped semicircular valley, a conic valley, a rectangular valley, a line-shaped valley, a cross-shaped valley and other irregular-shaped valleys. Moreover, the depth of the overflow valley is preferably larger than 0.2 mm, but it is not limited thereto.

The structure having space reserved for gel overflow according to the present invention provides an overflow valley inside the fastening portion used for combining a screwing component in order to prepare space for gel overflow in thin and/or ultra-thin electronic products. Furthermore, as the height of the fastening portion can be shorter than that of the prior art, and the structure will not occupy much inner space of the electronic product. Comparing with the prior art, the structure of the present invention can also save material consumption and manufacturing cost, simplify circuit layout and minimize the size of the motherboard and the electronic product by shortening the length of the fastening portion and the screwing component.

### BRIEF DESCRIPTIONS OF THE DRAWINGS

FIG. 1 (PRIOR ART) is an exploded view showing a conventional structure of a notebook computer;

FIG. 2A (PRIOR ART) is an enlarged schematic diagram showing a conventional lock-hole of a notebook computer;

FIG. 2B (PRIOR ART) is a schematic diagram showing the conventional lock-hole of a notebook computer with a screwing component fastened therein;

FIG. 3 is a schematic diagram showing a structure having space reserved for gel overflow of an electronic product according to a first embodiment of the present invention;

FIG. 4 is a schematic diagram showing the structure having space reserved for gel overflow of FIG. 3 with a screwing component fastened therein; and

FIG. 5 is a schematic diagram showing a structure having space reserved for gel overflow of an electronic product according to a second embodiment of the present invention.

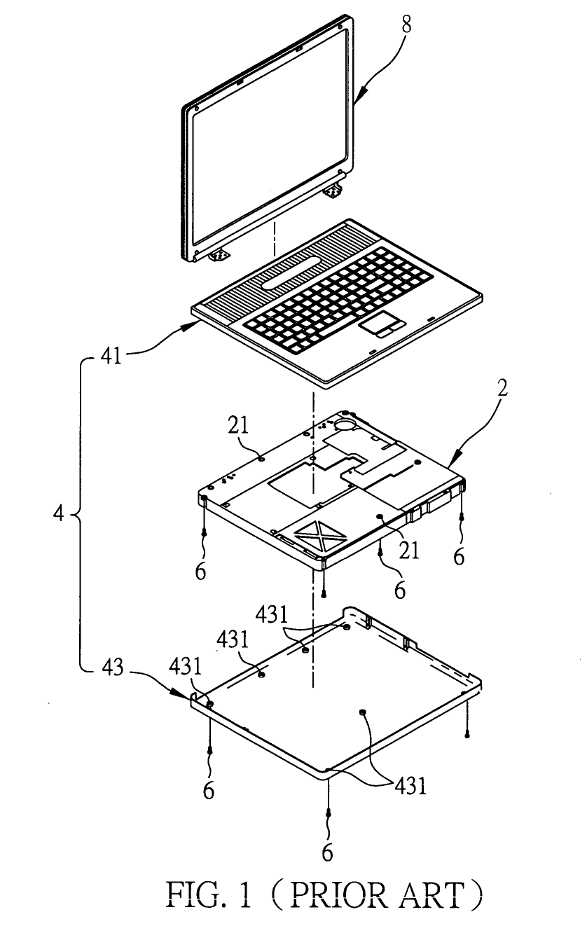

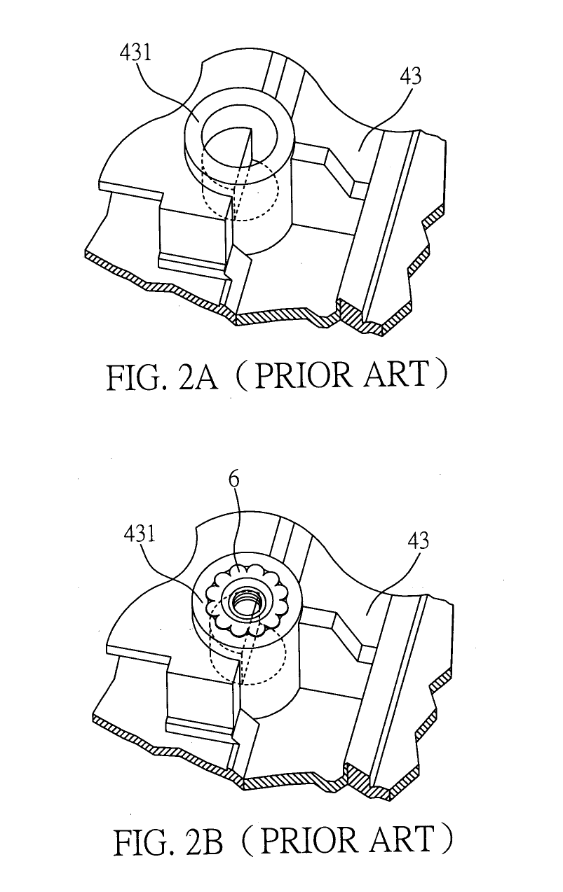

### DISCLOSURE OF THE INVENTION

The following illustrative embodiments are provided to illustrate the implementation of the structure having reserved space for gel overflow of the present invention applied to an electronic product, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

It should be noted that although the structure with reserved space for gel overflow of the present invention is illustrated in the context of a casing of the electronic product (e.g. a lower casing of a notebook computer), the present invention is not limited to this. As the structures of the notebook computer and the casing are conventional in the art, detailed descriptions thereof will be omitted for purpose of simplicity.

### First Embodiment

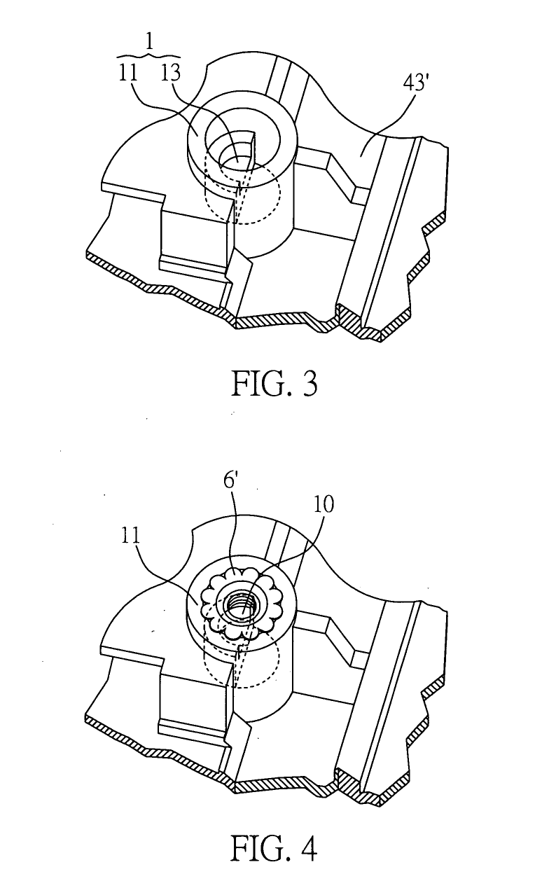

FIG. 3 and FIG. 4 are schematic diagrams showing a structure with space reserved for gel overflow of an electronic product according to a first embodiment of the present invention. As shown in FIG. 3, a structure 1 with space reserved for gel overflow of an electronic product is provided on a casing (for example, a lower casing 43′) of the electronic product, wherein the overflow structure 1 at least includes a fastening portion 11 (for example, a lock-hole) and an overflow valley 13 provided in an inner rim of the fastening portion 11.

The fastening portion 11 combines with a screwing component 6′ for assembling the casing of the electronic product. In this embodiment, the fastening portion 11 is a circular opening and the height of the fastening portion 11 projected over the outer and inner surface of the lower casing 43 is equal to that of the prior art so as not to affect the plane balance of the electronic product. Although a circular opening extended from the outer surface of the lower casing 43′ is illustrated as an example of the fastening portion 11 in the present embodiment, the structure of the fastening portion is not limited thereto. It should be understood to those with ordinary skills in the art that any fastening portion formed on the outer surface of the lower casing 43′ for fixing the screwing component 6′ can be used. For example, the height of the fastening portion 11 with respect to the inner surface of the lower casing 43′ can be lower than that of the prior art or level with the outer surface of the lower casing, and it can be of any appropriate shape.

The overflow valley 13 may be formed as a stepped semicircular valley by drilling the fastening portion 11, but it is not limited thereto. For instance, the overflow valley 13 can be formed while forming the casing to save drilling time. Meanwhile, the depth of the overflow valley 13 is preferably larger than 0.2 mm in order to provide more overflow space, however the depth of the overflow valley is also not limited thereto.

As shown in FIG. 4, when the screwing component 6′ (such as a screw or a nail) is locked in the fastening portion 11 in a conventional manner, the hot gel is deposited in the overflow valley 13 at the inner rim of the fastening portion 11. Accordingly, the defect of the prior art that the interference between the inserted screwing component 6′ and the lower casing 43′ can be avoided.

Meanwhile, as the height of the fastening portion 11 can be shorted to be level with the outer surface of the lower casing 43′ or shorter than the height of the inner surface of the lower casing 43′, thickness of the overall computer structure and size of the motherboard can be reduced and circuit layout can be simplified.

Additionally, imbalanced and complicated computer structure and high cost mentioned in the prior arts can be overcome without adding a plurality of supporting portions according to the present invention. Moreover, material and time can be saved as the overflow structure reserved for gel overflow of the present invention can be formed at the same time of forming the casing. Further, the length of the screwing component 6′ can be shortened by reducing the height of the fastening portion 11. As a result, the overflow structure reserved for gel overflow of the electronic product according to the present invention can save material and manufacturing cost.

Therefore, the space structure reserved for gel overflow of the electronic product according to the present invention can solve the defects of the prior arts and has the abovementioned numerous effects and high industrial applicability.

### Second Embodiment

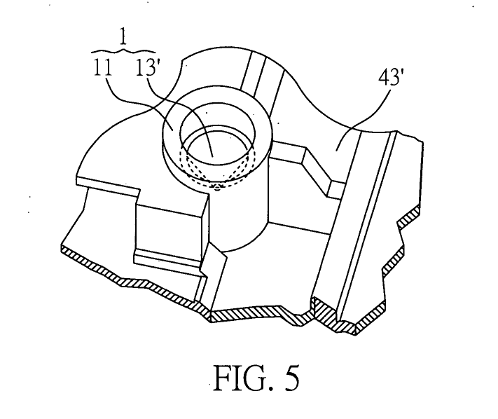

FIG. 5 is a schematic diagram showing a structure reserved for gel overflow of an electronic product according to a second embodiment of the present invention, wherein components that are same or similar to those of the first embodiment are represented by the same or similar reference numbers and the detailed descriptions thereof are omitted in order to simplify the disclosure of the present invention.

The major difference between the first and second embodiment is the shape of the overflow valley 13. The overflow valley 13 of the first embodiment is a stepped semicircular valley while the overflow valley 13′ of the second embodiment is a conic valley, thus the casing structure is simpler.

As shown in FIG. 5, the overflow valley 13′ of the present embodiment is a conic valley concaved from the inner rim of the fastening portion 11, and the depth of the valley can be larger than or equal to that of the first embodiment. The hot gel can also be deposited in the overflow valley 13′ while the screwing component is fastened to the fastening portion, such that the interference between the screwing component and the casing can also be effectively prevented. Furthermore, due to the simplicity of the casing structure, price of the formed mould and required material for forming the casing can be decreased, thereby reducing the manufacturing cost.

It should be noted that any overflow space capable of depositing hot gel can be used according to the present invention. Alternatively, the structure is not limited to the overflow valley 13 and 13′ mentioned in the above embodiments. Variations can be devised according to practical demands, for example, the overflow valley may be rectangular, line-shape, cross-shape or other proper shapes. Meanwhile, the structure reserved for gel overflow formed on the lower casing is illustrated in the above embodiments, but can be provided at appropriate places where overflow of gel is to be avoided.

As a result, the structure having space reserved for gel overflow of an electronic product such as a notebook computer in the present invention can save space and material and is accorded with the purposes of miniaturized electronic products and lower cost. Therefore, the structure having space reserved for gel overflow according to the present invention can solve the defects of the prior arts and has more design flexibility and high industrial applicability.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A structure having space reserved for gel overflow of an electronic product provided on a casing of the electronic product, comprising:
a fastening portion for combining with a screwing component to assemble the casing of the electronic product; and
an overflow valley provided in inner rim of the fastening portion for depositing hot gel therein generated when combining the screwing component, thereby avoiding interference between the screwing component and the casing.

2. The structure having space reserved for gel overflow of claim 1, wherein the fastening portion is a lock-hole.

3. The structure having space reserved for gel overflow of claim 1, wherein the fastening portion is a circular opening.

4. The structure having space reserved for gel overflow of claim 1, wherein the fastening portion is a structure extended from an outer surface of the casing.

5. The structure having space reserved for gel overflow of claim 1, wherein the fastening portion is a structure that levels with an outer surface of the casing.

6. The structure having space reserved for gel overflow of claim 1, wherein the fastening portion is a structure projected out of an outer surface of the casing.

7. The structure having space reserved for gel overflow of claim 1, wherein the overflow valley may be one of a stepped semicircular valley, a conic valley, a rectangular valley, a line-shaped valley, a cross-shaped valley and an irregular valley.

8. The structure having space reserved for gel overflow of claim 1, wherein the depth of the overflow valley is larger than 0.2 mm.
